(19) United States
(12) Patent Application Publication
(10) Pub. No.: US 2015/0223412 A1
(43) Pub. Date: Aug. 13, 2015

(54) Plant Cage

(71) Applicants: Brian Vanderwall-Arnold, Kewadin, MI (US); Edwin Cooper McIntyre, Kewadin, MI (US)

(72) Inventors: Brian Vanderwall-Arnold, Kewadin, MI (US); Edwin Cooper McIntyre, Kewadin, MI (US)

(21) Appl. No.: 14/537,558

(22) Filed: Nov. 10, 2014

Related U.S. Application Data
(60) Provisional application No. 61/901,980, filed on Nov. 8, 2013.

(51) Int. Cl. A01G 17/04

(52) U.S. Cl. CPC A01G 17/04

(57) ABSTRACT

A plant cage for placement about a plant for assisting in plant growth. At least three vertical rods are arranged relative to one another to define a three-dimensional area into which the plant is locatable. One or more ring members have a circular shape and are formed from two separate components that are pivotal relative to one another to provide an open position for the cage. Two fasteners are connectable to each of the two ring ends. Grommets are disposed on the rods and connect to the ring member, and are positioned at a vertical height along the rods.

### RELATED APPLICATIONS

This application claims priority to application Ser. 61/901,980 having a filing date of Nov. 8, 2013, which is also incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a plant cage, and more particularly, to a plant cage that may be assembled from component pieces that may lie flat during storage.

Plants may be caged by a support structure which is purchased by the user in a fully assembled state, having lateral supporting arms welded to vertical supports. Such support structure is pulled down over the top of a plant which is then allowed to grow up into the cage. The width or “bushiness” of the plant about which the support structure is positioned, makes the positioning of such support structure difficult. Plant branches may be broken or bent during cage positioning. Further, at the end of the plant growing season, the support structures are grouped together and stored in a large area to receive the structures.

It is therefore, an object of the present invention to provide a new and useful plant cage.

It is a further object to provide a plant cage that may be assembled and disassembled from discrete components.

It is yet another object of the present invention to provide a method for assembling a plant cage from discrete components.

### BRIEF SUMMARY OF THE INVENTION

These and other objects of the invention are achieved in a plant cage of at least three rods, at least two rings and grommets for securing the rings to the rods. In one embodiment, circular shaped rings have two separate sections that are connected at the ends of the sections. The connectors provide a pivoting mode to present the cage in an open position to allow the cage to be positioned around the plant, and thereafter permit the cage to be closed to surround the plant.

### BRIEF DESCRIPTION OF SEVERAL VIEWS OF THE DRAWINGS

FIG. 1 is a perspective view of a plant cage according to a preferred embodiment of the invention.

FIG. 2 is a perspective view of the plant cage of FIG. 1 shown in an open position.

FIG. 3 is a partial perspective view of a hinge mechanism of the plant cage of FIG. 1.

FIG. 4 is a side view of a rod and grommet of the plant cage of FIG. 12.

FIG. 5 is a side perspective view of four rods and one ring being assembled into the plant cage of FIG. 1.

FIG. 6 is a partial perspective view of the plant cage of FIG. 1.

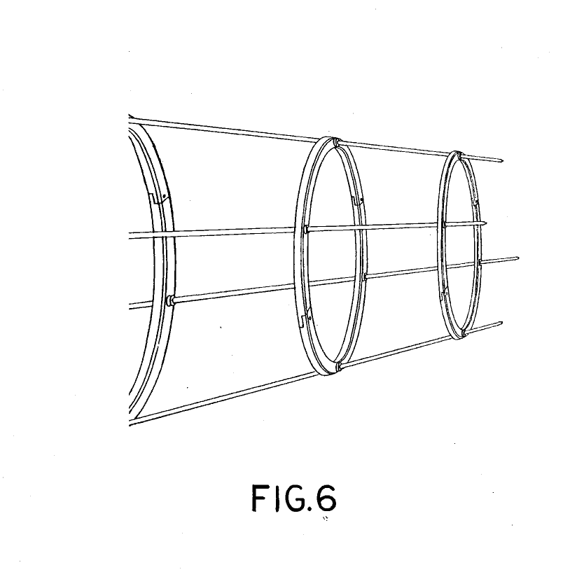

FIG. 7 is a perspective view of the plant cage of FIG. 1.

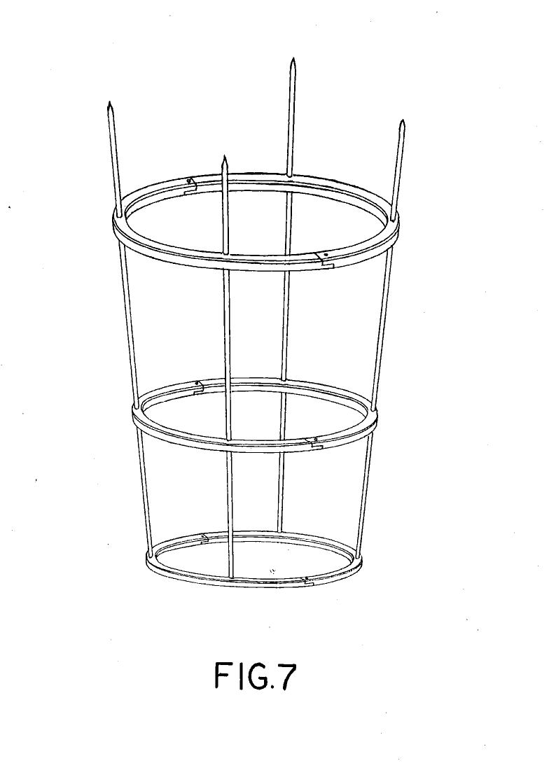

FIG. 8 is a partial perspective view of a plant cage embodiment having three rods and two rings, and showing the separated components of a hinge mechanism.

FIG. 9 is a perspective view of the plant cage of FIG. 1 shown in an open position.

FIG. 10 shows a partial perspective view of one rod, one ring and one grommet of the plant cage of FIG. 1.

FIG. 11 shows a partial perspective view of the plant cage of FIG. 1 and showing the separated components of the hinge mechanism.

FIG. 12 is a perspective view of the plant cage of FIG. 1 shown in an open position.

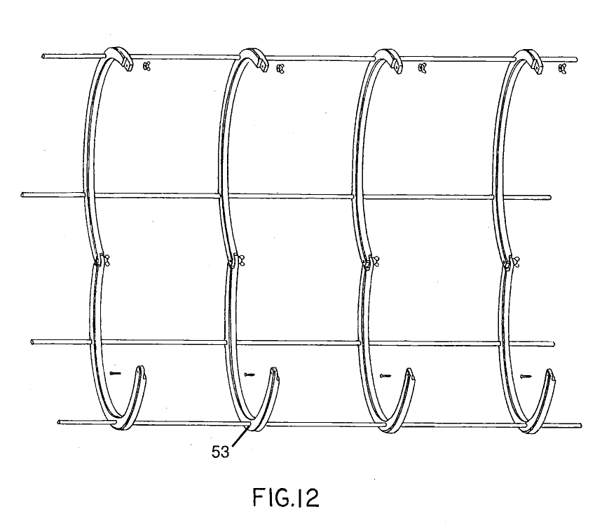

FIG. 13 is a perspective view of the plant cage of FIG. 1 shown in a closed position.

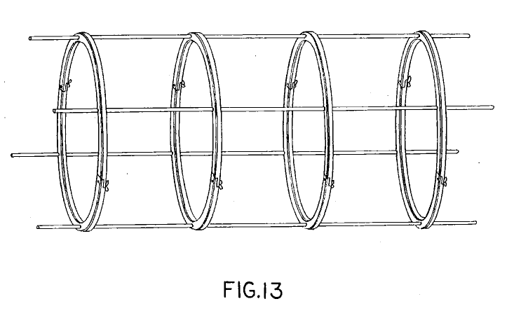

### DETAILED DESCRIPTION OF THE PREFERRED EMBODIMENT

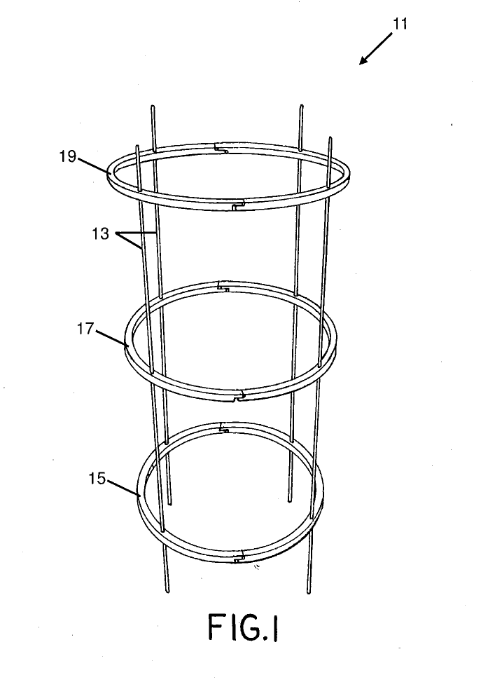

Referring to FIG. 1, a plant cage 11 aids in crop growing by providing a support structure to the limbs and the stalk of a plant. Cage 11 may be totally free standing, or it may be anchored into soil. Cage 11 may be located out of doors in an open field, for example, or may be located in a greenhouse free from weather concerns. Cage 11 is free standing and thus, serves to eliminate any stress on the limbs or on the roots of the plant that is caged.

As shown in FIG. 1, cage 11 is formed of four separate rods 13 and three separate rings 15, 17 and 19. Rods 13 and rings 15, 17 and 19 are of a green color.

Rods and rings 13 are cylindrical in shape, and may be formed from metal, wood, plastic, or any other material that will provide sufficient strength to allow the cage to stand upright, to hold the three rings, and to be sturdy against plant movement caused by the wind or weather. The length of each rod 13 may vary depending on the type of plant involved, but as an example, may be 36 inches in length. The diameter of each rod 13 is continuous along its length, and may be of various dimensions, for example, ¼ inches, ⅜ inches, ½ inches, ⅝ inches. Of course, smaller diameters may be used, again depending on the plant, the weather, etc. Larger diameters may also be used.

Rings 15, 17 and 19 are each circular in shape having, for example, a 20 inch diameter. The rings are vertically adjustable along the rods 13 and may thus be positioned at several different heights. The user places the rings on rods 13 at a height that is needed. In view of the location of plant limbs, the rings may be located accordingly, making pruning and harvesting more easy, and removing stress on plant limbs.

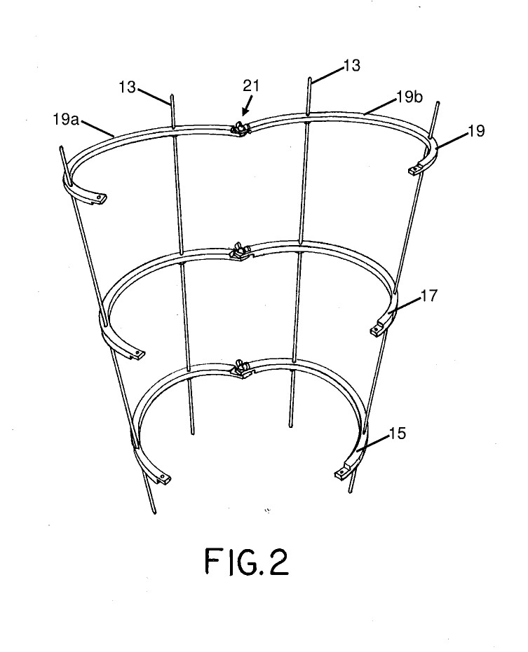

Referring to FIG. 2, each ring 15, 17, 19 is constructed of two separate portions that are pivotally mounted together. For example, ring 19 includes two portions 19A and 19B. The separate portions 19A, 19B are connected together at their ends. A hinge mechanism 21 is shown in FIG. 2 being located at one point along the circumference of ring 19 so as to permit ring 19 to be openable within the plane of the ring's circumference. Each of the two separate portions 19A, 19B are moveable relative to one another and may be opened to 180 degrees. The portions 19A, 19B pivot at the one point on the ring's circumference. Each ring 15, 17, 19 is formed of two separate portions, and thus, cage 11 may be completely opened in half, in two like-size segments as shown in FIG. 2.

Cage 11, in its open position of FIG. 2, may be placed up against a plant, with portion 19A located adjacent the plant. Thereafter, the open cage 11 is closed, by moving portion 19B to pivot on hinge mechanism 21 and meet with portion 19A to form a continuous circular or cylindrical shape about the plant. Once the rings are moved to a closed position, the other ends of the ring portions are secured together holding the rings closed. The cage, thus located around the plant, may be forced vertically into the soil, if so desired.

Cage 11 is easily disassembled into its component parts of four rods 13 and three rings 15, 17 and 19. The separate component parts may be stored flat when not in use.

As will suggest itself, less than or more than three rings may be positioned onto the rods 13 to form plant cage 11. Also, rings 15, 17 and 19 may be designed by the inclusion of less than or more than four rod-receiving holes to accept, for example three rods 13 or more than four rods 13, if desired.

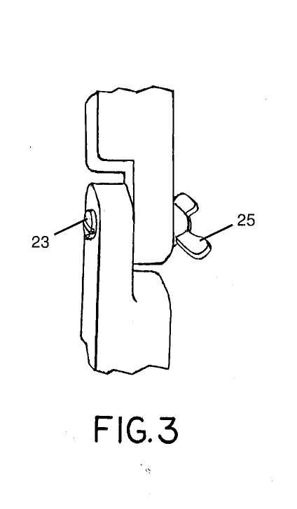

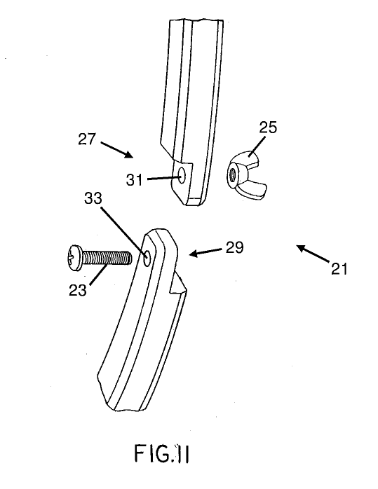

Referring to FIGS. 3, 8 and 11, hinge mechanism 21 is formed from a bolt 23 and a wing nut 25. Wing nut 25 mates with bolt 23 to screwingly turn along the threads of bolt 23 to tighten or loosen the bolt to the wing nut, i.e., to vary the spacing between the head of the bolt and the wing nut.

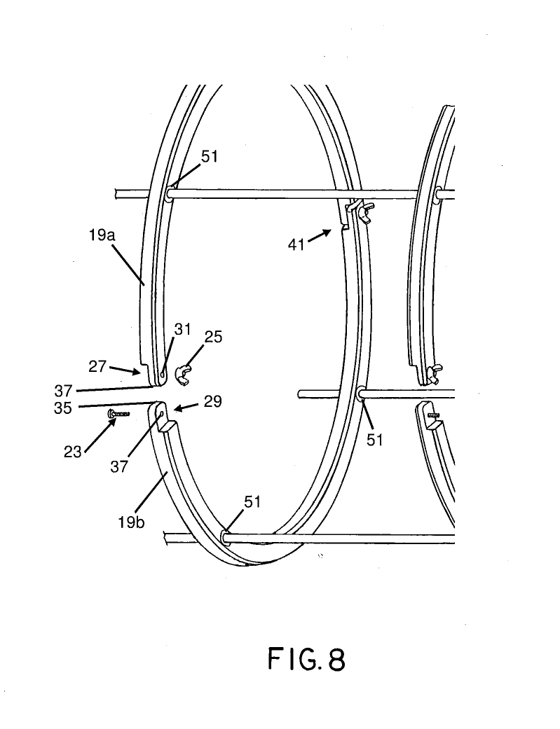

As shown in FIG. 8, the ends 27, 29 of ring portions 19A, 19B are shaped in an L-shape to mate ends 27, 29 with one another. A pair of holes 31, 33 are formed in each end of ring portions 19A, 19B respectively, and are alignable and of a size for receiving bolt 23. Corners 35, 37 of ends 27, 29 of ring potions 19A, 19B are shaped or rounded so as to permit rotational movement of one ring portion relative to another ring portion. As understood, the location of holes 31, 33 and the dimension of the shape of L-shaped ends 27, 29 allow free rotation to a certain angle, preferably 180 degrees in a full open position.

As shown in FIG. 8 at reference numeral 41, the other two ends of ring portions 19A, 19B also have a hinge connection with similar bolt and wing nut connection and similar end shapes. Thus, either side of the cage may be opened and rotated. One of the bolts 23 and wing nut 25 is removed and the other bolt and wing nut is loosened to permit rotation on the bolt about the bolt's axis.

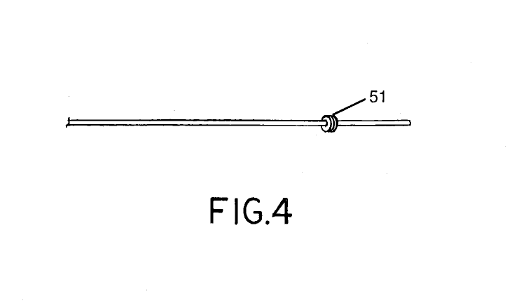

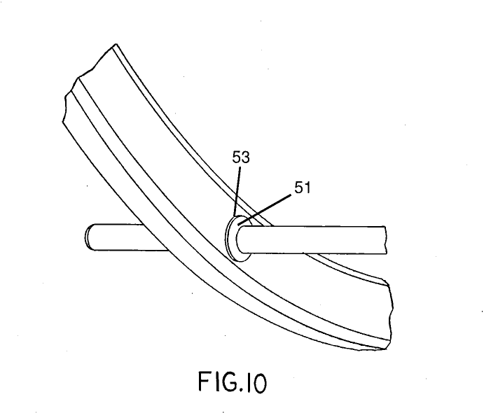

Referring to FIGS. 4, 8 and 10, a plurality of grommets 51 are slidable over rods 13, and serve to hold a ring to a rod, in a secure fashion. Grommet 51 is sized with an aperture to engage and elastically mate with the rod 13 to grasp the rod. Grommet 51 is also sized at its outer periphery to engage the ring via an aperture 53 formed in the ring.

Grommet 51 may be made from rubber, plastic or other rubber like material that may elastically deformed and mate with the structure of the ring forming aperture 53 to hold the grommet in place and tightly to the ring. Thus, grommet 51 is formed of rubber or plastic that is inserted into a hole in a ring and frictionally retained there, while presenting an aperture to receive a rod and frictionally retain the rod. The grommets may be placed on the rods first and then the rings secured or located to the ring.

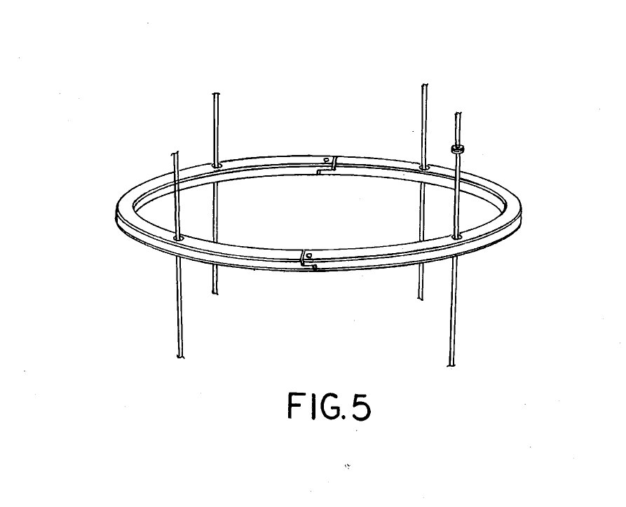

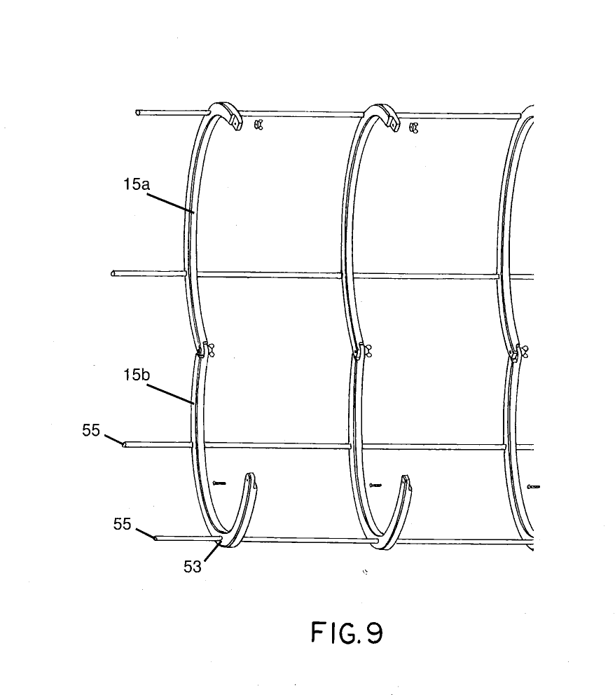

Referring to FIGS. 5 and 9, four grommets 51 are initially slid over an end 55 of each of four rods, and each grommet is positioned approximately four inches from each end 55 of the rod. After which, a single ring 15, including its two portions 15A and 15B, is slid over the four rods, the four rods slide through the holes 53 in ring 15 until ring 15 sets onto the four grommets as shown in FIG. 9. The grommet may be pressed into the hole 53 so as to engagingly grasp the ring. Alternatively, as will suggest itself, the grommet may merely provide a rest stop for the ring to lie on top of the grommet.

After the first ring 15 is in place on the four rods and secured by the four grommets, the structure is stood upright. The cage at this point may be in an open or closed position. Then, another four grommets are slid over the four rod, about half way down the length of the rods. The second ring 17 is then slid onto the four rods until the ring 17 rests on the grommets. The rings are oriented so that the bolts are on the lower side of the rings, as shown in FIG. 9.

After the second ring 17 is in place on the four rods, four more grommets are placed on the rods at a desired height, and the final ring 19 is slid over the rods and mated with the grommets. Thereafter, final adjustments may be made as to the height of each ring. The open cage is then placed relative to a plant and closed around it.

Alternatively, the four rods may first be placed around the plant and forced down into soil; thereafter, each of rings 15, 17, 19 in their closed circular state may be positioned and secured with grommets about the four rods and about the plant.

While the invention has been described with reference to certain embodiments, it will be understood by those skilled in the art that various modifications in form and detail may be made therein without departing from the scope and spirit of the invention. Accordingly, modifications such as those suggested above, but not limited thereto, are to be considered within the scope of the invention.

1. A plant cage for placement about a plant for supporting the plant to assist in plant growth, comprising:
at least three vertical support members, each arranged relative to another to define a three-dimensional area into which the plant is locatable;
at least one ring member having a continuous circumferential ring shape, said ring member formed from two separate ring components each having two ends, said two ends of each ring component having an aperture receiving one of said vertical support members;
two fasteners each connectable to the other at each of said two ends;
at least three grommets, each of said grommets disposed on one of said at least one ring member and on one said vertical support members and positioned at a vertical height along the one vertical support member.

2. The plant cage according to claim 1 wherein said fasteners allow pivoting of the two ring components relative to each other, at least one of said fasteners being removable from the end of said ring components and the other of said fasteners permitting said two ring components to pivot relative to each other.

3. The plant cage according to claim 1 wherein said ends of each ring component being configured with surfaces to allow mating of two of said ends of respective ring components and allow relative rotation of one ring component relative to the other ring component, said surfaces including beveled surfaces.

4. The plant cage according to claim 1 wherein said ends of each ring component includes a cylindrical aperture having an axis disposed orthogonal to the plane formed by said ring member.

5. The plant cage according to claim 1 wherein each of said fasteners comprising a wing nut and a threaded screw.

6. The plant cage according to claim 1 wherein said continuous circumferential shape being substantially cylindrical or elliptical or rectangular or square or polynomial.

7. The plant cage according to claim 1 wherein each said grommet being formed from a material which is flexible and having an aperture of a size to slidingly receive a said vertical support member, and being slideable along said vertical support member and sized to frictionally engage said vertical support member so as to frictionally secure itself at a position on said vertical support member so as to support a ring member resting upon or frictionally secured to said grommet.

8. The plant cage according to claim 1 wherein said ring member having an aperture of a size for receiving one of said vertical support members.

9. The plant cage according to claim 1 wherein the components thereof may be made in custom sizes including the height thereof.

10. Apparatus according to claim 1 wherein said at least three vertical support members include four vertical support members.

11. A kit for providing a plant cage to be placed about a plant for assisting in plant growth, comprising:
at least three vertical support members; being arrangeable relative to one another and so as to define a three-dimensional area into which the plant may be located;
at least three grommets, each of said grommets having an aperture for slidingly receiving a vertical support member and positionable along said vertical support to a first location;
at least two ring components connectable together to form a ring member having a circumferential ring shape, each of said at least two ring components having two ends and being connectable at said ends to the ends of at least one other of said ring components, at least one said ring component having an aperture for slidingly receiving a said vertical support member, and wherein said ring member is slidably positioned relative to and in contact with said grommets; and
a plurality of fasteners, each fastener connecting two ends of two ring components.

12. A method for constructing a plant cage, for placement about a plant, using at least three vertical support members, at least two ring members, each comprised of two ring components pivotably connected at one end and connectable at the other end, two sets of three grommets and at least one fastener, comprising:
positioning the three vertical support members in an upright position;
sliding each of the three grommets along one of said three vertical support members to a first vertical height position;
sliding one ring member of said ring members onto and along said three vertical members to said first vertical height position including resting said one ring member on the first set of grommets;
sliding each of a second set of three grommets along one of said three vertical support members to a second vertical height position located above said first vertical height position; and
sliding another ring member of said second ring members onto and along said three vertical members to said second height position including resting said another ring member onto the second set of grommets.

13. A method for constructing a plant cage according to claim 11 and further comprising:
pivoting the two ring components of each of said two ring members at said one end and into an open position wherein a sufficient space is provided by the open ring components to receive the plant;
positioning said two-pivoted open ring components relative to the plant;
pivoting the two ring components into a closed position about the plant, including moving said vertical supports, so as to form a three dimensional area within which the plant is disposed; and
connecting said other ends of said two ring components.

14. A method according to claims 12 wherein the steps may be performed in any order.

15. A method according to claims 13 wherein the steps may be performed in any order.
